(19) United States
(12) Patent Application Publication
(10) Pub. No.: US 2014/0157026 A1
(43) Pub. Date: Jun. 5, 2014

(54) METHODS AND APPARATUS FOR DYNAMICALLY ADJUSTING A POWER LEVEL OF AN ELECTRONIC DEVICE

(71) Applicants: ATI TECHNOLOGIES ULC, Markham (CA); ADVANCED MICRO DEVICES, INC., Sunnyvale, CA (US)

(72) Inventors: Ming L. So, Danville, CA (US); Xiaogang Zheng, Sunnyvale, CA (US); ChangHwa Lee, Cupertino, CA (US); Francisco L. Duran, Austin, TX (US); Wayne Louie, Port Perry (CA); Stephen H. Cheng, Markham (CA)

(73) Assignees: ADVANCED MICRO DEVICES, INC., Sunnyvale, CA (US); ATI TECHNOLOGIES ULC, Markham (CA)

(21) Appl. No.: 13/705,539

(22) Filed: Dec. 5, 2012

(51) Int. Cl. G06F 1/26

(52) U.S. Cl. CPC G06F 1/26
USPC 713/323

(57) ABSTRACT

Methods and apparatus for dynamically adjusting a power level of an electronic device (100) are disclosed. In an embodiment, an electronic device (100) receives a usage pattern of the electronic device (100) (e.g., typically used 9:00 AM to 5:00 PM on weekdays). The electronic device (100) then dynamically adjusts a wake up timer (204) associated with the electronic device (100) based on the usage pattern (e.g., expire at 8:50 am the next morning, which is 10 minutes before usage typically resumes for that day). In response to an expiration of the dynamically adjusted wake up timer (204), the electronic device (100) increases the power level of the electronic device (100) (e.g., transition from hibernate mode to standby mode, possibly via other intervening power modes, for faster startup in anticipation of resumed usage).

### TECHNICAL FIELD

The present disclosure relates in general to electronic devices, and, in particular, to methods and apparatus for dynamically adjusting a power level of an electronic device.

### BACKGROUND

Many portable electronic devices are capable of entering one or more power modes. For example, most portable computers have an on mode (S0), a standby mode (S3), a hibernate mode (S4), and an off mode (S5). In the on mode, all, or substantially all, systems in the computer are powered up. For example, a typical portable computer will deliver power to input devices, such as a keyboard, output devices, such as a display, and internal circuitry, such as dynamic random access memory (DRAM). In the standby mode, power to many systems, such as the display and hard drive, is turned off. However, in the standby mode, the DRAM remains powered to save the current context of the computer (e.g., the user's work). In the hibernate mode, the current context of the computer is saved to a nonvolatile memory (e.g., a hard drive or flash memory) so that it can be restored later, and then the DRAM is powered down in addition to the other systems (e.g., the display and hard drive). In the off mode, all or substantially all systems are powered down, and the context is not saved to nonvolatile memory.

Most computers allow the user to manually and/or automatically place the computer into standby mode and/or hibernate mode. For example, a user that intends to use his battery powered computer again in a relatively short period of time (e.g., 30 minutes), may manually place the computer in to standby mode. Conversely, a user that does not intend to use his computer again for awhile, may manually place the computer into hibernate mode. The user may also set timers to automatically place the computer in to standby mode and/or hibernate mode after a certain period of inactivity. For example, the user may indicate that the computer should automatically go into standby mode after 30 minutes of battery powered inactivity and hibernate mode after two hours of battery powered inactivity.

Each of these modes has certain power and startup time tradeoffs. For example, a typical portable computer can transition from standby mode to on mode in less than five seconds. However, the power consumed (i.e., the current drain) in the standby mode is significantly higher than the powered consumed in the hibernate mode. As a result, the battery of the device does not last as long in the standby mode as it does in the hibernate mode. Conversely, a typical portable computer can take as much as a minute or more to transition from hibernate mode to on mode. As a result, the mode selected by the user or automatically entered by the timers suffers from either high current drain or slow startup time.

### BRIEF DESCRIPTION OF THE DRAWINGS

FIG. 1 is a block diagram of an example electronic device that may benefit from a dynamically adjusted power level.

FIG. 2 is a block diagram of an example circuit for dynamically adjusting a power level of an electronic device.

FIG. 3 is a block diagram of another example circuit for dynamically adjusting a power level of an electronic device.

FIG. 4 is a block diagram of yet another example circuit for dynamically adjusting a power level of an electronic device.

FIG. 5 is a flowchart of an example process for dynamically adjusting a power level of an electronic device.

FIG. 6 is a flowchart of another example process for dynamically adjusting a power level of an electronic device.

FIG. 7 is a flowchart of yet another example process for dynamically adjusting a power level of an electronic device.

FIG. 8 is a flowchart of still another example process for dynamically adjusting a power level of an electronic device.

### DETAILED DESCRIPTION OF THE PREFERRED EMBODIMENTS

Briefly, methods and apparatus for dynamically adjusting a power level of an electronic device are disclosed. In an embodiment, a memory stores a usage pattern of the electronic device (e.g., typically in use from 9:00 AM to 5:00 PM on weekdays). A dynamic wake up timer, operatively coupled to the memory, expires at a time that is based on the usage pattern (e.g., expire at 8:50 am the next morning, which is 10 minutes before usage typically resumes for that day). A power controller, operatively coupled to the dynamic wake up timer, increases the power level of the electronic device in response to the dynamic wake up timer expiring (e.g., transition from hibernate mode to standby mode, possibly via other intervening power modes for typically relatively short periods of time in certain embodiments, for faster startup in anticipation of resumed usage).

Among other features, dynamically placing the computer in hibernate mode when the user is statistically unlikely to use the computer saves a significant amount of battery life because a significant portion of the computer, such as the display, hard drive, and DRAM is powered down. In addition, switching the computer from the hibernate mode to a standby mode shortly before the user is statistically likely to start using the computer again creates a quick startup experience for the user (e.g., the computer may return to full operational mode in less than five seconds as opposed to over one minute).

In one example, the usage pattern includes a dynamically modified usage pattern based on a prediction formula associated with the activity of the electronic device 100. In one example, the usage pattern includes times of day and days of week. In one example, the usage pattern includes a moving average, a cyclic pattern, and/or a weighted aggregation associated with activity of the electronic device. In one example, the activity of the electronic device includes user activity and background application activity.

In another embodiment, a memory stores a usage pattern of the electronic device (e.g., e.g., 9:00 AM to 5:00 PM on weekdays). A dynamic sleep timer, operatively coupled to the memory, expires at a time that is based on the usage pattern (e.g., expire if there is no user activity and no background computer activity, such as keystrokes or music playing, for ten minutes after 5:00 PM). A power controller, operatively coupled to the dynamic sleep timer, decreases the power level of the electronic device in response to the dynamic sleep timer expiring (e.g., transition to hibernate mode to conserve battery).

In another embodiment, a memory (e.g., DRAM and/or flash) is structured to store a usage pattern associated with the electronic device (e.g., a certain portable computer is typically used from 9:00 AM to 5:00 PM on weekdays). A power controller operatively coupled to the memory is structured to select a first power mode, the first power mode having a first current drain (e.g., the portable computer is on and fully operational). An inactivity timer operatively coupled to the power controller is structured to time an inactivity period (e.g., the computer is not used for 30 minutes). The power controller is also structured to select a second power mode in response to the inactivity period exceeding a first threshold, the second power mode having a second current drain, the second current drain being lower than the first current drain (e.g., put the computer in hibernate mode by saving the current state of the DRAM to a hard drive or flash memory and then powering down most systems such as the display, hard drive, and the DRAM). A wake up timer operatively coupled to the power controller is structured to determine a wake up time based on the usage pattern (e.g., wake up on the next weekday at 8:45 AM). The power controller is also structured to select a third power mode in response to the wake up timer expiring, the third power mode having a third current drain, the third current drain being lower than the first current drain and higher than the second current drain (e.g., put the computer in standby mode by recovering DRAM from the hard drive and applying power to DRAM, but do not power up the display and/or other systems yet). A user input device (e.g., lid switch or button) operatively coupled to the power controller is structured to receive a user generated wake up event (e.g., lid opening). The power controller is also structured to select the first power mode in response to receiving the user generated wake up event (e.g., go back to the on mode).

In one example, the memory is structured to store a usage pattern that has been dynamically modified based on activity associated with the electronic device. In one example, the memory is structured to store a usage pattern based on times of day and days of week. In one example, the power controller is structured to cause a display, a processor, and a volatile memory to be on when in the first power mode. In one example, the inactivity timer is structured to determine a time between user inputs. In one example, the power controller is structured to cause a display, a processor, and a volatile memory to be off when in the second power mode. In one example, the wake up timer is set based on a time of day and day of week. In one example, the power controller is structured to cause a display to be off, a processor to be off, and a volatile memory to be on when in the third power mode. In one example, the user input device is at least one of a keyboard, a touch screen a mouse, and a near-field proximity detector.

Turning now to the drawings, and as described in detail below, one example of the presently disclosed system is a computer that records a plurality of usage patterns. The computer then dynamically adjusts its power mode based on the current computer activity. For example, when the computer is not actively being used, the computer may dynamically place itself in a hibernate mode (low current drain, slow start up time) based on the usage pattern and the current day and time. When the usage pattern indicates activity is likely to resume, the computer may dynamically place itself in to a standby mode (e.g., medium current drain, fast start up time). In this manner, the computer saves its battery while still providing a quick startup experience for the user by anticipating when the user is likely to resume using the computer again.

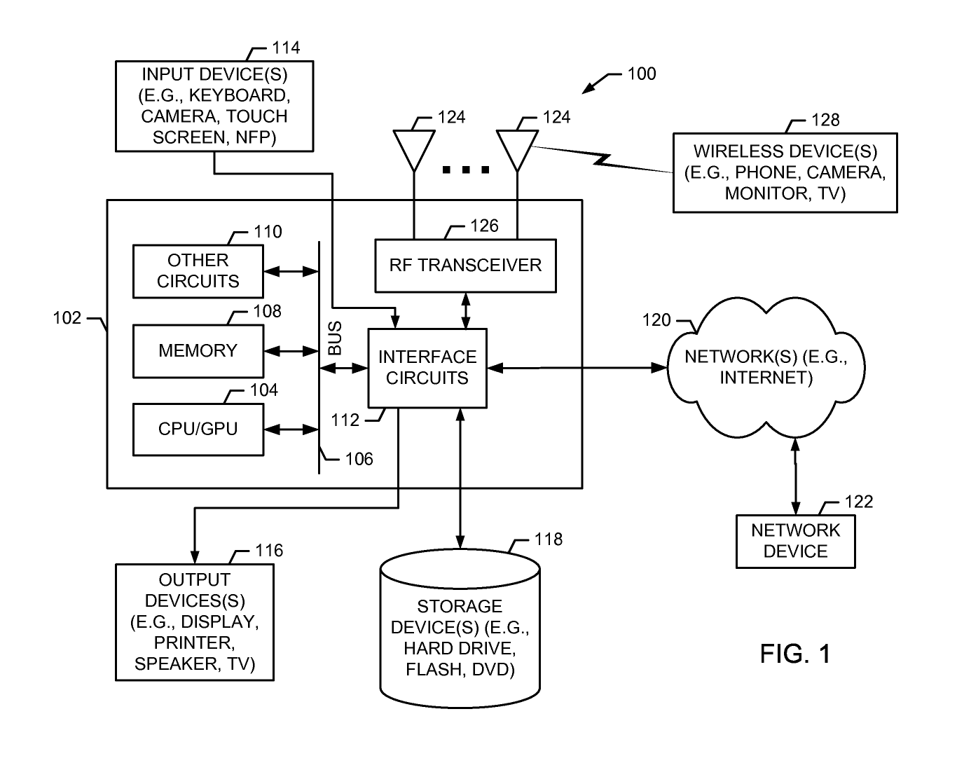

A detailed block diagram of the electrical systems of an example electrical device 100 is illustrated in FIG. 1. The electrical device 100 may be any suitable electrical device that uses one or more sleep modes. For example, the electrical device 100 may be a personal computer, a laptop computer, a tablet device, a client, a server, a camera, a phone, and/or a television. The example electrical device 100 includes a main unit 102 which may include one or more processors 104 electrically coupled by an address/data bus 106 to one or more memories 108, other computer circuitry 110, and one or more interface circuits 112. The processor 104 may be any suitable processor or plurality of processors. The memory 108 may include various types of non-transitory memory including volatile memory and/or non-volatile memory such as, but not limited to, distributed memory, read-only memory (ROM), random access memory (RAM) etc. The memory 108 typically stores a software program that interacts with the other devices in the system as described herein. This program may be executed by the processor 104 in any suitable manner. The memory 108 may also store digital data indicative of documents, files, programs, web pages, etc. retrieved from a server and/or loaded via an input device 114.

The interface circuit 112 may be implemented using any suitable interface standard, such as an Ethernet interface and/or a Universal Serial Bus (USB) interface. One or more input devices 114 may be connected to the interface circuit 112 for entering data and commands into the main unit 102. For example, the input device 114 may be a keyboard, mouse, touch screen, track pad, isopoint, camera, a voice recognition system, and/or a near-field proximity detector.

One or more displays, printers, speakers, monitors, televisions, high definition televisions, and/or other suitable output devices 116 may also be connected to the main unit 102 via the interface circuit 112. The display 116 may be a cathode ray tube (CRTs), liquid crystal displays (LCDs), or any other type of suitable display. The display 116 generates visual displays of data generated during operation of the device 100. For example, the display 116 may be used to display web pages and/or other content received from a server. The visual displays may include prompts for human input, run time statistics, calculated values, data, etc.

One or more storage devices 118 may also be connected to the main unit 102 via the interface circuit 112. For example, a hard drive, CD drive, DVD drive, and/or other storage devices may be connected to the main unit 102. The storage devices 118 may store any type of data used by the device 100.

The electrical device 100 may also exchange data with other networked electrical devices 122, such as a client and/or a server via a connection to a network. The network connection may be any type of network connection, such as an Ethernet connection, digital subscriber line (DSL), telephone line, coaxial cable, etc. Users of the system may be required to register with a server. In such an instance, each user may choose a user identifier (e.g., e-mail address) and a password which may be required for the activation of services. The user identifier and password may be passed across the network using encryption built into the user's browser. Alternatively, the user identifier and/or password may be assigned by the server.

In some embodiments, the device 100 may be a wireless device. In such an instance, the device 100 may include one or more antennas 124 connected to one or more radio frequency (RF) transceivers 126. The transceiver 126 may include one or more receivers and one or more transmitters. For example, the transceiver 126 may be a cellular transceiver, a Bluetooth transceiver, and/or a WiFi transceiver. The transceiver 126 allows the device 100 to exchange signals, such as voice and data, with other wireless devices 128, such as a phone, camera, monitor, television, and/or high definition television. For example, the device may send and receive wireless telephone signals, text messages, audio signals and/or video signals.

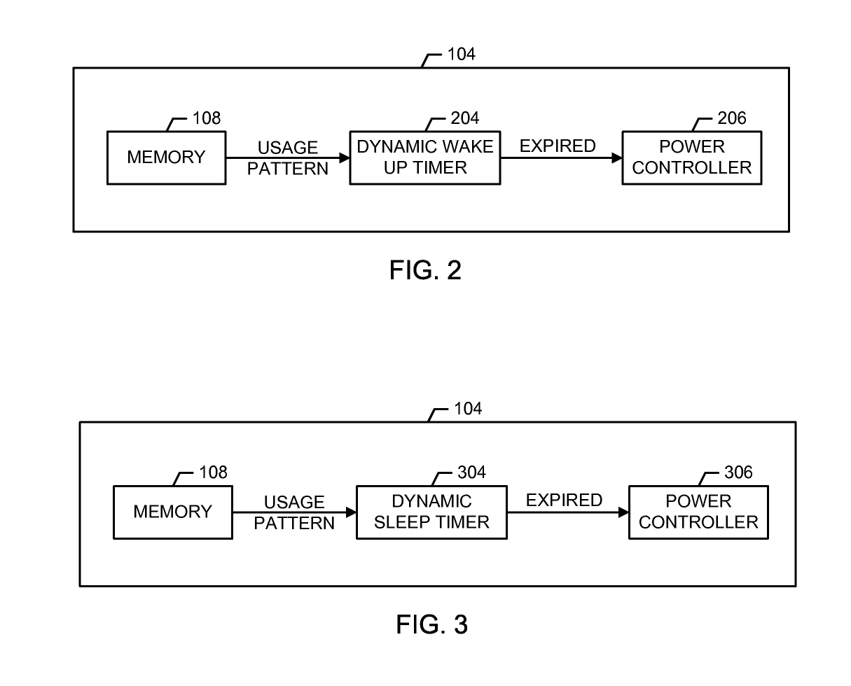

A block diagram of an example circuit for dynamically adjusting a power level of an electronic device is illustrated in FIG. 2. The circuit may be implemented in hardware or a combination of hardware and hardware executing software. In one embodiment the circuit may be embodied in one or more CPUs 104 executing software. Other suitable hardware may include one or more application specific integrated circuits (ASICs), state machines, field programmable gate arrays (FPGAs), and/or digital signal processors (DSPs).

In this example, a memory 108 stores a usage pattern associated with the electronic device 100. For example, the memory 108 may be a DRAM and/or a flash memory, and the usage pattern may be 10:00 AM to 11:00 AM and 2:00 PM to 3:00 PM on Saturday and Sunday and 8:30 AM TO 11:30 AM and 12:30 PM to 4:30 PM on Mondays, Tuesdays, Wednesdays, Thursdays, and Fridays.

The memory 108 passes the usage pattern associated with the electronic device 100 to a dynamic wake up timer 204. The dynamic wake up timer 204 dynamically adjusts a wake up time associated with the electronic device 100 based on the usage pattern. For example, the dynamic wake up timer 204 may set the wake up time to be at 8:50 am the next morning, which is 10 minutes before usage typically resumes on that day for this electronic device 100. When the dynamic wake up timer 204 expires, a power controller 206 increases the power level of the electronic device 100. For example, the power controller 206 may transition the electronic device 100 from a hibernate mode to a standby mode in anticipation of user activity to provide a quick transition back to the on mode. In some embodiments, each time the power controller 206 makes a power mode determination and/or transition, the electronic device may be in the on mode.

A block diagram of another example circuit for dynamically adjusting a power level of an electronic device is illustrated in FIG. 3. The circuit may be implemented in hardware or a combination of hardware and hardware executing software. In one embodiment the circuit may be embodied in one or more CPUs 104 executing software. Other suitable hardware may include one or more application specific integrated circuits (ASICs), state machines, field programmable gate arrays (FPGAs), and/or digital signal processors (DSPs).

In this example, a memory 108 stores a usage pattern associated with the electronic device 100. For example, the memory 108 may be a DRAM and/or a flash memory, and the usage pattern may be 10:00 AM to 11:00 AM and 2:00 PM to 3:00 PM on Saturday and Sunday and 8:30 AM TO 11:30 AM and 12:30 PM to 4:30 PM on Mondays, Tuesdays, Wednesdays, Thursdays, and Fridays.

The memory 108 passes the usage pattern associated with the electronic device 100 to a dynamic sleep timer 304. The dynamic sleep timer 304 dynamically adjusts a sleep time associated with the electronic device 100 based on the usage pattern. For example, the dynamic sleep timer 304 may set the sleep time to expire if there is no user activity (e.g., keystrokes) and no background computer activity (e.g., playing media, copying a large file, etc.) for ten minutes after 5:00 pm on a weekday, which is when usage typically stops on that day for this device. When the dynamic sleep timer 304 expires, a power controller 306 decreases the power level of the electronic device 100. For example, the power controller 306 may transition the electronic device 100 from an on mode to a hibernate mode to conserve battery power.

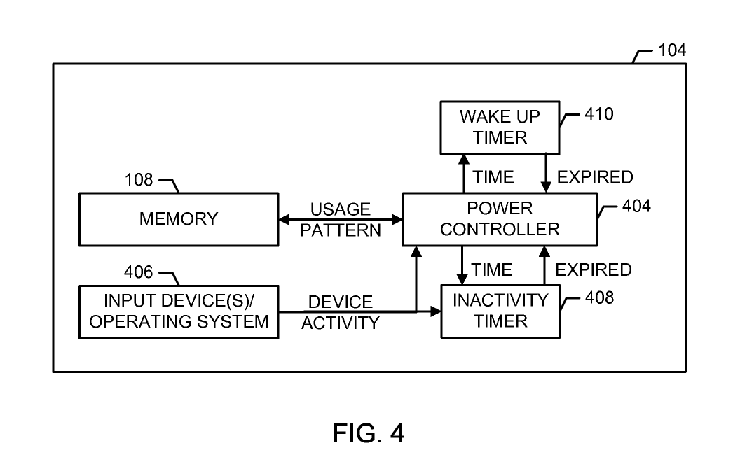

A block diagram of another example circuit for dynamically adjusting a power level of an electronic device is illustrated in FIG. 4. The circuit may be implemented in hardware or a combination of hardware and hardware executing software. In one embodiment the circuit may be embodied in one or more CPUs 104 executing software. Other suitable hardware may include one or more application specific integrated circuits (ASICs), state machines, field programmable gate arrays (FPGAs), and/or digital signal processors (DSPs).

In this example, a memory 108 stores a usage pattern associated with the electronic device. For example, the memory 108 may be a DRAM and/or a flash memory, and the usage pattern may be 10:00 AM to 11:00 AM and 2:00 PM to 3:00 PM on Saturday and Sunday and 8:30 AM TO 11:30 AM and 12:30 PM to 4:30 PM on Mondays, Tuesdays, Wednesdays, Thursdays, and Fridays.

The memory 108 passes the usage pattern associated with the electronic device 100 to a power controller 404. The power controller 404 selects a power mode for the electronic device 100 based on the usage pattern, the current day and time, and the current use of the electronic device 100. In order to determine the current use of the electronic device 100, the power controller 404 is operatively coupled to one or more user input devices and/or an operating system 406 and an inactivity timer 208. The user input device may be any suitable user input device such as a touch screen, a keyboard, a mouse, a near-field proximity detector, etc. Data indicative of computer activity may be sent to the power controller 404 from the input devices and/or the operating system 406 and/or other suitable process, circuit, devices, and/or systems such as the inactivity timer 408. Examples of computer activity include active input devices (e.g., keys being pressed, mouse being moved, network activity) and active computer processes (e.g., music being played, movie being watched, large files being copied). The power controller 404 may use the computer activity and the current day and time to modify the usage data stored in the memory 108. For example, if the user used to go out for lunch every day, but for the last three weeks has worked through lunch, the usage pattern for Noon to 1:00 may be modified accordingly.

The power controller 404 may set the inactivity timer 408 to a desired threshold of inactivity that warrants a change to the selected power mode and/or the threshold time may be set by the inactivity timer 408. For example, the power controller 404 may send data indicative of 30 minutes to the inactivity timer 408. If the inactivity timer 408 expires, the inactivity timer 408 alerts the power controller 404. At that time, the power controller 404 may change the power mode of the electronic device 100. For example, if the usage pattern indicates that there is typically activity during the current time of day, the power controller 404 may transition the electronic device 100 from the on mode to the standby mode in order to conserve some battery power while still providing a quick transition back to the on mode. Conversely, if the usage pattern indicates that there is typically no activity during the current time of day, the power controller 404 may transition the electronic device 100 from the on mode to the hibernate mode in order to conserve more battery power.

When the power controller 404 places the electronic device 100 in to a low power mode (e.g., hibernate), the power controller 404 may also program a wake up timer 410 with a time. For example, the power controller 404 may program the wake up timer 410 to alert the power controller 404 at 12:55 PM (e.g., after lunch) or at 8:45 AM the next weekday (e.g., shortly before the work day begins). When the wake up timer 410 expires, the power controller 404 may transition the electronic device 100 from the hibernate mode to the standby mode in anticipation of user activity to provide a quick transition back to the on mode. If the expected user activity does not occur within the inactivity time threshold, the power controller 404 may again look at the usage pattern and select the same or a different power mode. In some embodiments, each time the power controller 404 makes a power mode determination and/or transition, the electronic device may be in the on mode.

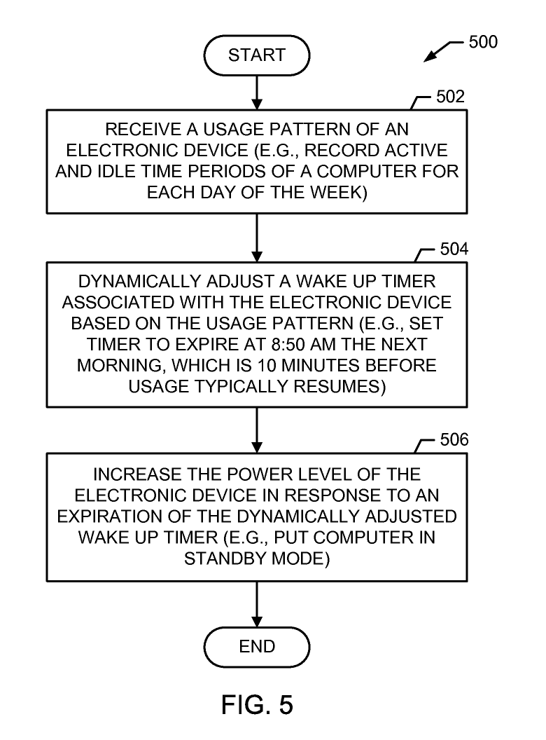

A flowchart of an example process 500 for dynamically adjusting a power level of an electronic device is illustrated in FIG. 5. The process 500 may be carried out by one or more suitably programmed controllers or processors executing software (e.g., block 104 of FIG. 1). The process 500 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

The example process 500 begins when an electronic device 100 receives a usage pattern of an electronic device 100 (block 502). For example, a portable computer may record active and idle time periods for each day of the week. Alternatively, or in addition, the electronic device 100 may store a model of the usage patterns based on a prediction formula associated with the activity of the electronic device 100. For example, the portable computer may calculate a moving average, a cyclic pattern, and/or a weighted aggregation associated with activity of the electronic device. The usage patterns may be stored in any suitable manner. For example, the electronic device 100 may store a data structure indicative of every five minute period in a week and whether the portable computer is typically in use during each such five minute period (e.g., based on the past five weeks).

The electronic device 100 then dynamically adjusts a wake up timer associated with the electronic device 100 based on the usage pattern (block 504). For example, a portable computer may set a timer to expire at 8:50 am the next morning, which is 10 minutes before usage typically resumes on that day for this electronic device 100. The electronic device 100 then increases the power level of the electronic device 100 in response to an expiration of the dynamically adjusted wake up timer (block 506). For example, the portable computer may enter a standby mode.

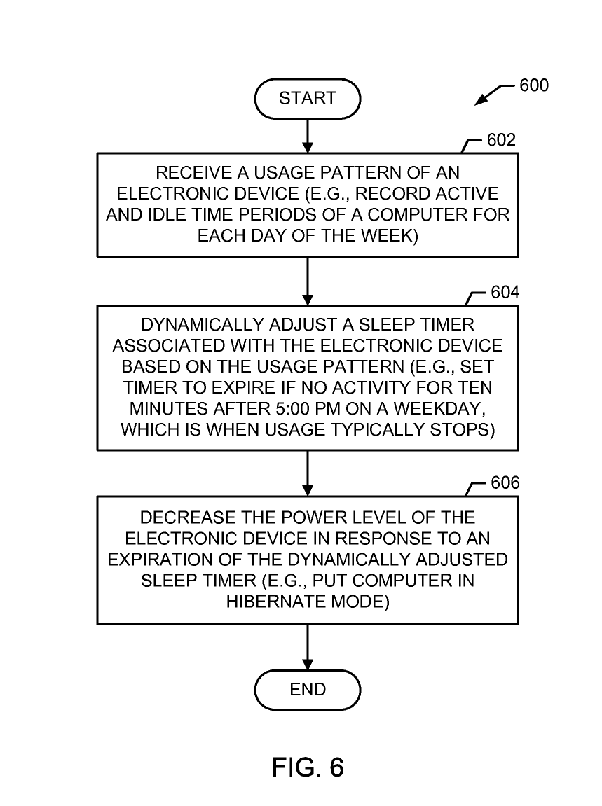

A flowchart of another example process 600 for dynamically adjusting a power level of an electronic device is illustrated in FIG. 6. The process 600 may be carried out by one or more suitably programmed controllers or processors executing software (e.g., block 104 of FIG. 1). The process 600 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 600 is described with reference to the flowchart illustrated in FIG. 6, it will be appreciated that many other methods of performing the acts associated with process 600 may be used. For example, the order of many of the operations may be changed, and some of the operations described may be optional.

The example process 600 begins when an electronic device 100 receives a usage pattern of an electronic device 100 (block 602). For example, a portable computer may record active and idle time periods for each day of the week. Alternatively, or in addition, the electronic device 100 may store a model of the usage patterns based on a prediction formula associated with the activity of the electronic device 100. For example, the portable computer may calculate a moving average, a cyclic pattern, and/or a weighted aggregation associated with activity of the electronic device. The usage patterns may be stored in any suitable manner. For example, the electronic device 100 may store a data structure indicative of every five minute period in a week and whether the portable computer is typically in use during each such five minute period (e.g., based on the past five weeks).

The electronic device 100 then dynamically adjusts a sleep timer associated with the electronic device 100 based on the usage pattern (block 604). For example, a portable computer may set timer to expire if there is no user activity and no background computer activity (e.g., playing media, copying a large file, etc.) for ten minutes after 5:00 pm on a weekday, which is when usage typically stops on that day for this device. The electronic device 100 then decreases the power level of the electronic device 100 in response to an expiration of the dynamically adjusted sleep timer (block 606). For example, the portable computer may enter a hibernate mode.

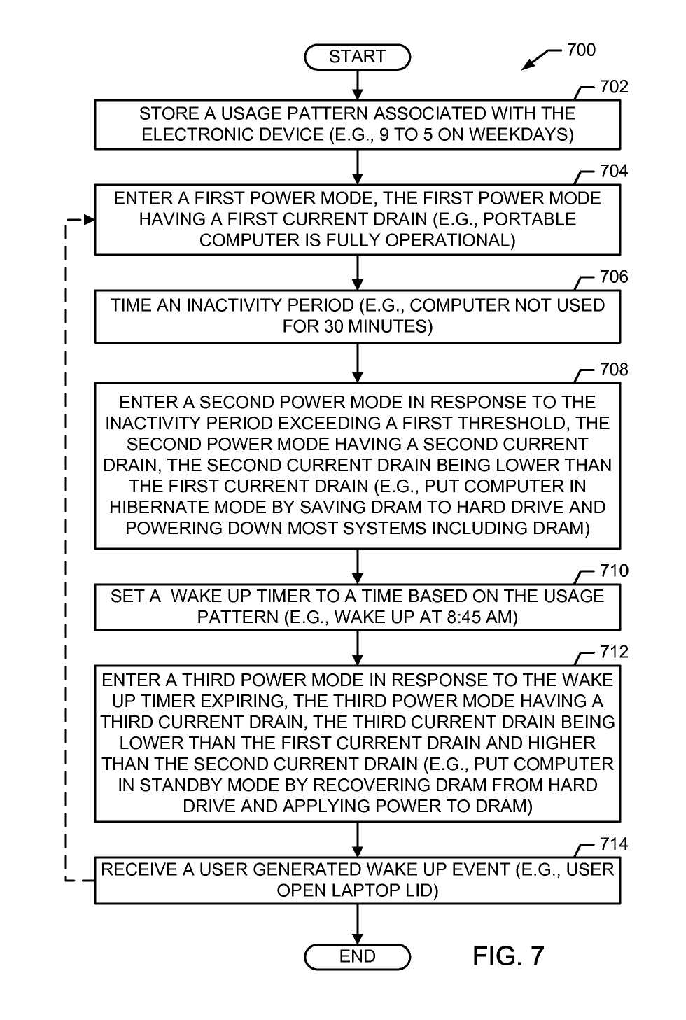

A flowchart of an example process 700 for dynamically adjusting a power level of an electronic device is illustrated in FIG. 7. The process 700 may be carried out by one or more suitably programmed controllers or processors executing software (e.g., block 104 of FIG. 1). The process 700 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 700 is described with reference to the flowchart illustrated in FIG. 7, it will be appreciated that many other methods of performing the acts associated with process 700 may be used. For example, the order of many of the operations may be changed, and some of the operations described may be optional.

In general, an electronic device 100 stores and dynamically modifies a usage pattern (e.g., 9:00 AM to 5:00 PM on weekdays). When the electronic device 100 is in use, the electronic device 100 times an inactivity period (e.g., 30 minutes) and enters a low power mode (e.g., hibernate mode) that includes saving volatile memory (e.g., DRAM) to nonvolatile memory (e.g., hard drive) and powering down volatile memory and other systems (e.g., display, processor, hard drive). Before entering the low power mode, the electronic device 100 sets a wake up timer based on the usage pattern (e.g., 8:45 AM). When the wake up timer expires, the electronic device 100 enters another low power mode (e.g., standby mode) that restores the volatile memory data and power. When the electronic device 100 receives a user generated wake up event (e.g., power button), the electronic device 100 is able to power up faster than if the electronic device 100 had been left in the other low power mode (e.g., hibernate). If the electronic device 100 does not receive the anticipated user wake up event within some period of time (e.g., 30 minutes), the electronic device 100 may return to the lower power mode (e.g., hibernate) and optionally repeat the process.

More specifically, the example process 700 begins when an electronic device 100 stores a usage pattern associated with the electronic device 100 (block 702). The usage pattern may be a data structure indicative of each minute of each day of the week and whether the electronic device 100 is typically used during each of those minutes. For example, the usage pattern for a device 100 may be that the device 100 is typically in use from 9:00 AM to 5:00 PM on weekdays. The usage pattern may be dynamically modified based on activity associated with the electronic device 100. For example, the usage pattern may be a moving average of weekly minute-by-minute use of the device 100

The electronic device 100 then enters a first power mode, the first power mode having a first current drain (block 704). For example, a portable computer may deliver power to a processor, a display and a volatile memory to place the portable computer in an on mode.

The electronic device 100 then times an inactivity period (block 706). For example, the electronic device 100 may determine that a time between user inputs has exceeded 30 minutes. The electronic device 100 then enters a second power mode in response to the inactivity period exceeding a first threshold, the second power mode having a second current drain, the second current drain being lower than the first current drain (block 708). For example, a portable computer may remove power to the processor, display and volatile memory after having stored the computer's volatile memory (e.g., DRAM) contents to a non-volatile memory (e.g., hard drive or flash memory) to place the portable computer in a hibernate mode. This operation is completed without losing what the user was working on, because the current state of the DRAM is saved to a hard drive or flash memory before the computer is powered down.

Alternatively, before entering this power mode, the portable computer may enter a different power mode. For example, the portable computer may set a wake up timer to 30 minutes and power down certain systems such as the display, processor, and hard drive. However, nonvolatile memory (e.g., DRAM) is not powered down in this mode and continues to hold the current context of the portable computer. In this mode, the portable computer is still drawing a significant amount of current in order to power the DRAM. However, the portable computer is drawing less current than when fully on, and the portable computer can be returned to the on mode relatively quickly (e.g., less than five seconds). In addition, one or more power modes may be disabled by a user and/or the operating system.

The electronic device 100 then sets a wake up timer to a time based on the usage pattern (block 710). For example, a portable computer may determine, based on a time of the day and/or based on a day of the week (e.g., after 5:00 PM on a week day), to set the wake up timer to 8:45 AM on the next week day to get the portable computer ready to power back up to the on mode quickly right before the portable computer is likely to be used again based on the usage pattern.

The electronic device 100 then enters a third power mode in response to the wake up timer expiring, the third power mode having a third current drain, the third current drain being lower than the first current drain and higher than the second current drain (block 712). For example, a portable computer may continue to remove power to a processor and a display, but deliver power to a volatile memory (e.g., DRAM) after the memory has been loaded from a non-volatile memory (e.g., hard drive or flash memory), to place the portable computer in a standby mode.

The electronic device 100 then receives a user generated wake up event (block 714). For example, the electronic device 100 may receive a keyboard input, a mouse input, a lid switch input, a near-field proximity detector input, etc. The electronic device 100 then enters the first power mode in response to receiving the user generated wake up event (block 704).

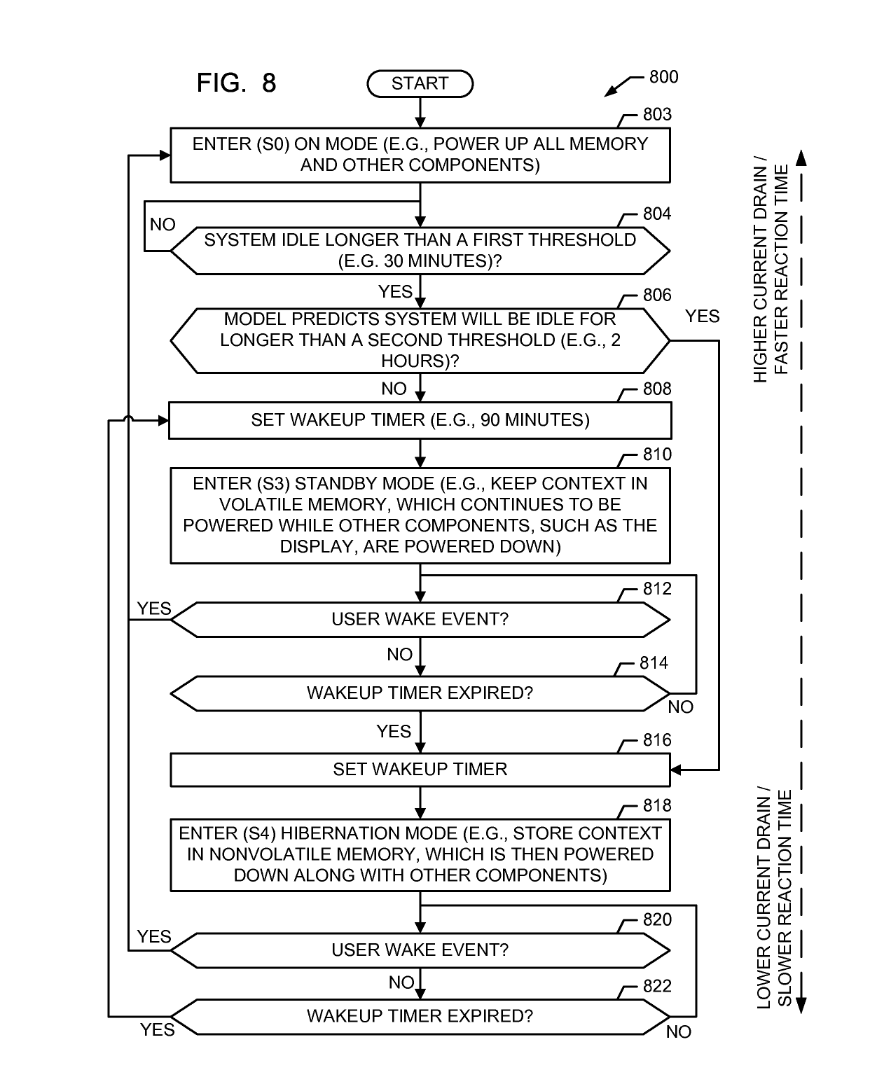

A flowchart of another example process 800 for dynamically adjusting a power level of an electronic device, or any other suitable device or system, is illustrated in FIG. 8. The process 800 may be carried out by one or more suitably programmed controllers or processors executing software (e.g., block 104 of FIG. 1). The process 800 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 800 is described with reference to the flowchart illustrated in FIG. 8, it will be appreciated that many other methods of performing the acts associated with process 800 may be used. For example, the order of many of the operations may be changed, and some of the operations described may be optional.

In general, an electronic device 100 periodically checks if it has been idle for some threshold period of time (e.g., 30 minutes). If the electronic device 100 has been idle, and a predicted further idle time (based on the usage pattern or model) exceeds a certain threshold (e.g., likely to be idle for at least another 90 minutes), the electronic device 100 sets a wake up timer based on a usage pattern (e.g., tomorrow morning at 8:45 AM) and enters a hibernate mode (low current drain, slow start up time). In this case, if the wake up timer expires before a user manually wakes up the device 100, the device 100 sets the wake up timer again (e.g., 2 hours) and enters standby mode (medium current drain, fast start up time) in anticipation of resumed activity. If the wake up timer expires again before the user manually wakes up the device 100, the device 100 may reevaluate the desired powered mode based on the current time/day and usage pattern. If the predicted further idle time does not exceed the threshold (e.g., only likely to be idle for less than another 90 minutes), the electronic device 100 sets the wake up timer (e.g., 2 hours) and enters a standby mode (medium current drain, fast start up time). In this case, if the wake up timer expires before a user manually wakes up the device 100, the device 100 may reevaluate the desired powered mode based on the current time/day and usage pattern.

More specifically, the example process 800 begins when an electronic device 100 enters the S0 on mode (block 802). For example, a portable computer may power up all, or substantially all, of its systems during user activity. Typical systems include a processor, a display, a hard drive, and DRAM. While in the on mode, the electronic device 100 periodically checks if the electronic device 100 has been idle for more than a first threshold period of time (block 804). For example, a portable computer may check if there has been no computer activity, such as key clicks, mouse movements, music playing, movie being watched, large files copied, network activity, etc. for more than 30 minutes.

If the electronic device 100 has been idle longer than the threshold time, the electronic device 100 determines if the usage pattern predicts that the electronic device 100 will be idle for longer than a second threshold (block 806). For example, a user may typically not use a certain portable computer after 5:00 PM on weekdays. Accordingly, if the current time is 5:30 PM on a weekday, the portable computer may predict that it will not be used for 14 hours, which exceeds a threshold of two hours. Conversely, if the current time is 11:30 AM on a weekday, the portable computer may predict that it will not be used for 30 minutes, which does not exceed a threshold of two hours.

If the predicted idle time does not exceed the threshold, the electronic device 100 sets a wake up timer (block 808) before entering the S3 standby mode (block 810). For example, a portable computer may set a wake up timer to 30 minutes and power down certain systems such as the display, processor, and hard drive. However, nonvolatile memory (e.g., DRAM) is not powered down and continues to hold the current context of the portable computer. In this mode, the portable computer is still drawing a significant amount of current in order to power the DRAM. However, the portable computer is drawing less current than when fully on, and the portable computer can be returned to the on mode relatively quickly (e.g., less than five seconds).

While in the standby mode, the electronic device 100 may be transitioned to the on mode by computer activity (block 812) or the wake up timer (block 814). If a user wake up event occurs, the electronic device returns to the on state (block 802). For example, if the user presses a power button or opens a laptop lid, the portable computer powers up all, or substantially all, systems such as the processor, display, and hard drive. In another example, a wake-on-LAN event may return the electronic device to the on state.

If the wake up timer expires, the electronic device 100 sets the same or a different wake up timer to the same or a different value (block 816) before entering the S4 hibernate mode (block 818). For example, a portable computer may set a wake up timer to 14 hours, save the current contents of volatile memory (e.g., DRAM) in nonvolatile memory (e.g., hard drive and/or flash memory), and then power down the volatile memory and other systems such as the display, processor, and hard drive. In this mode, the portable computer is drawing less current than when it is in standby mode because the volatile memory is not drawing current. However, the portable computer will need more time to return to the on mode (e.g., more than one minute).

While in the hibernate mode, the electronic device 100 may be transitioned to the on mode by computer activity (block 820) or the wake up timer (block 822). If a user wake up event occurs, the electronic device returns to the on state (block 802). For example, if the user presses a power button or opens a laptop lid, the portable computer powers up all, or substantially all, systems such as the processor, display, and hard drive.

If the wake up timer expires, the electronic device 100 sets the wake up timer again (block 808) before entering the S3 standby mode (block 810). For example, a portable computer may set the wake up timer to 30 minutes and power down certain systems such as the display, processor, and hard drive. However, nonvolatile memory (e.g., DRAM) is not powered down and continues to hold the current context of the portable computer. In this manner, the portable computer “anticipates” the user's return, and the portable computer can be returned to the on mode relatively quickly (e.g., less than five seconds) while still saving more battery power during times when the device 100 is unlikely to be used.

In summary, persons of ordinary skill in the art will readily appreciate that methods and apparatus for dynamically adjusting a power level of an electronic device have been provided. Among other features, putting the computer in hibernate mode when the user is statistically unlikely to use the computer saves a significant amount of battery life because a significant portion of the computer, such as the display, hard drive, and DRAM is powered down. In addition, switching the computer from the hibernate mode to a standby mode shortly before the user is statistically likely to start using the computer again creates a quick startup experience for the user (e.g., return to full operational mode in less than five seconds as opposed to over one minute).

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of dynamically adjusting a power level of an electronic device, the method comprising:
dynamically adjusting at least one of a wake up timer and a sleep timer, each of the wake up timer and sleeper timer associated with an electronic device based on a usage pattern of the electronic device; and
adjusting the power level of the electronic device in response to an expiration of the dynamically adjusted the at least one of the wake up timer and the sleep timer.

2. The method of claim 1, further comprising receiving the usage pattern of the electronic device

3. The method of claim 2, wherein receiving the usage pattern associated with the electronic device includes storing a dynamically modified usage pattern based on activity associated with the electronic device.

4. The method of claim 2, wherein receiving the usage pattern associated with the electronic device includes storing the usage pattern in association with times of day and days of week.

5. The method of claim 2, wherein receiving the usage pattern associated with the electronic device includes determining at least one of a moving average, a cyclic pattern, and a weighted aggregation associated with activity of the electronic device.

6. The method of claim 5, wherein activity of the electronic device includes user activity and background application activity.

7. An apparatus for dynamically adjusting a power level of an electronic device, the apparatus comprising:
a timer, wherein at least one of a wake up time and a sleep time associated with the timer is dynamically adjusted based on a usage pattern of the electronic device; and
a power controller operatively coupled to the timer, wherein the power controller adjusts the power level of the electronic device in response to an expiration of the dynamically adjusted timer.

8. The apparatus of claim 7, further comprising a memory storing the usage pattern of the electronic device.

9. The apparatus of claim 8, wherein the usage pattern includes a dynamically modified usage pattern based on activity associated with the electronic device.

10. The apparatus of claim 8, wherein the usage pattern includes times of day and days of week.

11. The apparatus of claim 8, wherein the usage pattern includes at least one of a moving average, a cyclic pattern, and a weighted aggregation associated with activity of the electronic device.

12. The apparatus of claim 11, wherein activity of the electronic device includes user activity and background application activity.

13. A method of dynamically adjusting a power level of an electronic device, the method comprising:
storing a usage pattern associated with the electronic device;
entering a first power mode, the first power mode having a first current drain;
timing an inactivity period;
entering a second power mode in response to the inactivity period exceeding a first threshold, the second power mode having a second current drain, the second current drain being lower than the first current drain;
setting a wake up timer to a time based on the usage pattern;
entering a third power mode in response to the wake up timer expiring, the third power mode having a third current drain, the third current drain being lower than the first current drain and higher than the second current drain;
receiving a user generated wake up event; and
entering the first power mode in response to receiving the user generated wake up event.

14. The method of claim 13, wherein storing the usage pattern associated with the electronic device includes dynamically modifying the usage pattern based on activity associated with the electronic device.

15. The method of claim 13, wherein storing the usage pattern associated with the electronic device includes storing the usage pattern in association with times of day and days of week.

16. The method of claim 13, wherein entering the first power mode includes delivering power to a display, a processor, and a volatile memory.

17. The method of claim 13, wherein timing the inactivity period includes determining a time between user inputs.

18. The method of claim 13, wherein entering the second power mode includes removing power to a display, a processor, and a volatile memory.

19. The method of claim 13, wherein setting the wake up timer includes setting the wake up timer based on a time of day and a day of week.

20. The method of claim 13, wherein entering the third power mode includes removing power to a display, removing power to a processor, and delivering power to a volatile memory.

21. The method of claim 13, wherein receiving the user generated wake up event includes receiving at least one of a keyboard input, a touch screen input, a lid switch input, a power button input, a mouse input, and a near-field proximity detector input.

22. An apparatus for dynamically adjusting a power level of an electronic device, the apparatus comprising:
a memory structured to store a usage pattern associated with the electronic device;
a power controller operatively coupled to the memory, the power controller being structured to select a first power mode, the first power mode having a first current drain;
an inactivity timer operatively coupled to the power controller, the inactivity timer being structured to time an inactivity period;
the power controller being structured to select a second power mode in response to the inactivity period exceeding a first threshold, the second power mode having a second current drain, the second current drain being lower than the first current drain;
a wake up timer operatively coupled to the power controller, the wake up timer being structured to determine a wake up time based on the usage pattern;
the power controller being structured to select a third power mode in response to the wake up timer expiring, the third power mode having a third current drain, the third current drain being lower than the first current drain and higher than the second current drain;
an user input device operatively coupled to the power controller, the user input device being structured to receive a user generated wake up event; and
the power controller being structured to select the first power mode in response to receiving the user generated wake up event.

23. The apparatus of claim 22, wherein the memory is structured to store a usage pattern that has been dynamically modified based on activity associated with the electronic device.

24. The apparatus of claim 22, wherein the memory is structured to store a usage pattern associated with times of day and days of week.

25. The apparatus of claim 22, wherein the power controller is structured to cause a display to be on, a processor to be on, and a volatile memory to be on when in the first power mode.

26. The apparatus of claim 22, wherein the inactivity timer is structured to determine a time between user inputs.

27. The apparatus of claim 22, wherein the power controller is structured to cause a display to be off, a processor to be off, and a volatile memory to be off when in the second power mode.

28. The apparatus of claim 22, wherein the wake up timer is set based on a time of day and a day of week.

29. The apparatus of claim 22, wherein the power controller is structured to cause a display to be off, a processor to be off, and a volatile memory to be on when in the third power mode.

30. The apparatus of claim 22, wherein the user input device is at least one of a keyboard, a touch screen, a lid switch input, a power button input, a mouse, and a near-field proximity detector input.

31. A computer readable memory storing a software, the software enabling an apparatus to:
store a usage pattern associated with the electronic device;
enter a first power mode, the first power mode having a first current drain;
timing an inactivity period;
enter a second power mode in response to the inactivity period exceeding a first threshold, the second power mode having a second current drain, the second current drain being lower than the first current drain;
set a wake up timer to a time based on the usage pattern;
enter a third power mode in response to the wake up timer expiring, the third power mode having a third current drain, the third current drain being lower than the first current drain and higher than the second current drain;
receive a user generated wake up event; and
enter the first power mode in response to receiving the user generated wake up event.

32. The computer readable memory of claim 31, wherein the software enables the apparatus to dynamically modify the usage pattern based on activity associated with the electronic device.

33. The computer readable memory of claim 31, wherein the software enables the apparatus to store the usage pattern in association with times of day and days of week.

34. The computer readable memory of claim 31, wherein the software enables the apparatus to deliver power to a display, a processor, and a volatile memory in the first power mode.

35. The computer readable memory of claim 31, wherein the software enables the apparatus to determine a time between user inputs.

36. The computer readable memory of claim 31, wherein the software enables the apparatus to remove power to a display, a processor, and a volatile memory in the second power mode.

37. The computer readable memory of claim 31, wherein the software enables the apparatus to set the wake up timer based on a time of day and day of week.

38. The computer readable memory of claim 31, wherein the software enables the apparatus to remove power to a display, remove power to a processor, and deliver power to a volatile memory in a third power mode.

39. The computer readable memory of claim 31, wherein the software enables the apparatus to receive at least one of a keyboard input, a touch screen input, a lid switch input, a power button input, a mouse input, and a near-field proximity detector input.
